(19) United States
(12) Patent Application Publication
(10) Pub. No.: US 2020/0014481 A1
(43) Pub. Date: Jan. 9, 2020

(54) NETWORK ASSISTED LTE CRS INTERFERENCE MITIGATION

(71) Applicant: Intel Corporation, Santa Clara, CA (US)

(72) Inventors: Andrey Chervyakov, Nizhny Novgorod (RU); Alexey Vladimirovich Khoryaev, Nizhny Novgorod (RU); Dmitry Belov, Nizhny Novgorod (RU); Axel Clausen, Munich (DE)

(21) Appl. No.: 16/482,995

(22) PCT Filed: Jan. 23, 2018
(86) PCT No.: PCT/US2018/014837

§ 371 Date: Aug. 1, 2019

Related U.S. Application Data
(60) Provisional application No. 62/453,966, filed on Feb. 2, 2017.

(51) Int. Cl. H04J 11/00; H04L 25/02; H04L 5/00

(52) U.S. Cl. CPC H04J 11/0056; H04L 25/0224; H04J 2211/005; H04J 11/0079; H04J 2211/001; H04L 5/0048

(57) ABSTRACT

An apparatus of user equipment (UE) comprises processing circuitry and memory. The processing circuitry decodes radio resource control (RRC) signaling received from an enhanced node B (eNB), wherein the RRC signaling includes an information element (IE) including information of a multi-cast broadcast single frequency network (MBSFN) subframe pattern of neighboring cells of a serving cell of the eNB. The processing circuitry initiates detection of CRS information of neighboring cells by the UE, the CRS information including one or both of physical cell identifiers (Cell IDs) and a number of CRS antenna ports (APs) of the neighboring cells; and initiates neighboring cell CRS interference mitigation (CRS-IM) using the detected CRS information and the received information of the MBSFN subframe pattern. The memory stores the information of the MBSFN subframe pattern.

### PRIORITY APPLICATION

This application claims the benefit of priority to U.S. Provisional Application Ser. No. 62/453,966, filed Feb. 2, 2017, which is incorporated herein by reference in its entirety.

### TECHNICAL FIELD

Various embodiments may relate generally to the field of wireless communications. Some embodiments relate to radio access networks (e.g. Third Generation Partnership Project Long Term Evolution (3GPP LTE) networks, as well as fifth generation (5G) new radio (NR) networks), and in particular to systems, devices, and methods for performing inter-cell cell-specific reference signal interference mitigation (CRS-IM).

### BACKGROUND

Radio access networks can be used for delivering voice communications to user equipment such as a mobile cellular telephone or a smart phone. A cellular telephone network includes fixed location transceivers distributed over land areas. The enhanced node B (eNB) transceivers and the areas that they serve can be referred to as cells of the cellular network. A cell-specific reference signal (CRS) is transmitted from a serving cell of the network to assist user equipment (UE) in estimation of characteristics of channels or carriers of the cellular network. However, interference of reference signals transmitted by cells neighboring to the serving cell can negatively impact downlink communication to the UE. Thus, there are general needs for devices, systems and methods that provide a robust protocol for communication between UEs and the network.

### BRIEF DESCRIPTION OF THE DRAWINGS

FIG. 1 is a diagram of a portion of an end-to-end network architecture of a wireless network with various components of a radio access network (RAN) in accordance with some aspects.

FIG. 2 is a flow diagram of a method of implementing inter-cell cell-specific reference signal interference mitigation (CRS-IM) for user equipment (UE) of a RAN in accordance with some aspects.

FIG. 3 illustrates UE of a RAN in accordance with some aspects.

FIG. 4 illustrates a multi-protocol baseband processor in accordance with some aspects.

FIG. 5 shows an example of information elements (IEs) received by UE for cell-specific reference signal assistance (CRS Assistance) in accordance with some aspects.

FIG. 6 illustrates an enhanced node B (eNB) in accordance with some aspects.

FIG. 7 is a flow diagram of a method of sending CRS Assistance signaling in accordance with some aspects.

FIG. 8 is a flow diagram of another method of sending CRS Assistance signaling in accordance with some aspects.

### DESCRIPTION OF EMBODIMENTS

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Radio frequency devices that communicate using a radio access network include mobile user equipment (UE) such as cell phones, laptop computers, and tablet computers. The UE communicates with a cell that connects the user equipment to the backhaul of the cell network. A cell-specific reference signal (CRS) is transmitted from a serving cell of the network to assist user equipment in estimation of characteristics of channels or carriers of the cellular network. However, interference of reference signals transmitted by cells neighboring the serving cell can negatively impact downlink communication to the UE. Interference mitigation by receivers at the UE side may improve downlink performance, but the information needed for the interference mitigation can add to the overhead signaling used to establish communications between UE and the network. It may be possible for UE to autonomously detect information needed to perform interference mitigation from reference signals. This would reduce the signaling overhead. However, autonomous detection of all the information needed to perform interference mitigation is not practical. A better approach includes a compromise between autonomous detection by the UE and transmitting interference mitigation assistance parameters by the network.

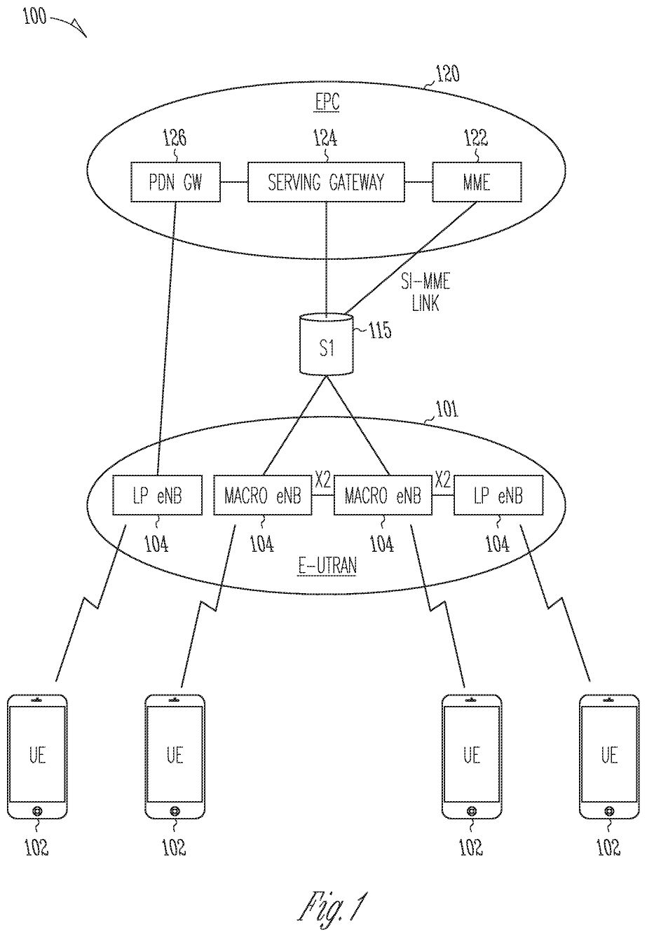

FIG. 1 is a diagram of a portion of an end-to-end network architecture of a wireless network with various components of the network in an aspect. The network 100 comprises a radio access network (RAN) (shown as an E-UTRAN or evolved universal terrestrial radio access network) and the core network 120 (e.g., shown as an evolved packet core (EPC)) coupled together through an S1 interface 115. For convenience and brevity sake, only a portion of the core network 120 is shown as well as the RAN 101.

The core network 120 includes mobility management entity (MME) 122, serving gateway (serving GW) 124, and packet data network gateway (PDN GW) 126. The RAN 101 includes enhanced node Bs (eNBs) 104 (which may operate as base stations (BSs)) for communicating with user equipment (UE) 102. The eNBs 104 may include macro eNBs and low power (LP) eNBs.

The MME 122 is similar in function to the control plane of legacy Serving GPRS Support Nodes (SGSN). The MME manages mobility aspects in access such as gateway selection and tracking area list management. The serving GW 124 terminates the interface toward the RAN 101, and routes data packets between the RAN 101 and the core network 120. In addition, it may be a local mobility anchor point for inter-eNB handovers and also may provide an anchor for inter-3GPP mobility. Other responsibilities may include lawful intercept, charging, and some policy enforcement. The serving GW 124 and the MME 122 may be implemented in one physical node or separate physical nodes. The PDN GW 126 terminates an SGi interface toward the packet data network (PDN). The PDN GW 126 routes data packets between the EPC 120 and the external PDN, and may be a key node for policy enforcement and charging data collection. It may also provide an anchor point for mobility with non-LTE accesses. The external PDN can be any kind of IP network, as well as an IP Multimedia Subsystem (IMS) domain. The PDN GW 126 and the serving GW 124 may be implemented in one physical node or separated physical nodes.

The eNBs 104 (macro and micro) terminate the air interface protocol and may be the first point of contact for a UE 102. In some embodiments, an eNB 104 may fulfill various logical functions for the RAN 101 including but not limited to RNC (radio network controller functions) such as radio bearer management, uplink and downlink dynamic radio resource management and data packet scheduling, and mobility management. In accordance with embodiments, UEs 102 may be configured to communicate OFDM communication signals with an eNB 104 over a multicarrier communication channel in accordance with an OFDMA communication technique. The OFDM signals may comprise a plurality of orthogonal subcarriers.

The S1 interface 115 is the interface that separates the RAN 101 and the EPC 120. It is split into two parts: the S1-U, which carries traffic data between the eNBs 104 and the serving GW 124, and the S1-MME, which is a signaling interface between the eNBs 104 and the MME 122. The X2 interface is the interface between eNBs 104. The X2 interface comprises two parts, the X2-C and X2-U. The X2-C is the control plane interface between the eNBs 104, while the X2-U is the user plane interface between the eNBs 104.

With cellular networks, LP cells are typically used to extend coverage to indoor areas where outdoor signals do not reach well, or to add network capacity in areas with very dense phone usage, such as train stations. As used herein, the term low power (LP) eNB refers to any suitable relatively low power eNB for implementing a narrower cell (narrower than a macro cell) such as a femtocell, a picocell, or a micro cell. Femtocell eNBs are typically provided by a mobile network operator to its residential or enterprise customers. A femtocell is typically the size of a residential gateway or smaller, and generally connects to the user's broadband line. Once plugged in, the femtocell connects to the mobile operator's mobile network and provides extra coverage in a range of typically 30 to 50 meters for residential femtocells. Thus, a LP eNB might be a femtocell eNB since it is coupled through the PDN GW 126. Similarly, a picocell is a wireless communication system typically covering a small area, such as in-building (offices, shopping malls, train stations, etc.), or more recently in-aircraft. A picocell eNB can generally connect through the X2 link to another eNB such as a macro eNB through its base station controller (BSC) functionality. Thus, LP eNB may be implemented with a picocell eNB since it is coupled to a macro eNB via an X2 interface. Picocell eNBs or other LP eNBs may incorporate some or all functionality of a macro eNB. In some cases, this may be referred to as an access point base station or enterprise femtocell.

In some embodiments, a downlink resource grid may be used for downlink transmissions from an eNB to a UE. The grid may be a time-frequency grid, called a resource grid, which is the physical resource in the downlink in each slot. Such a time-frequency plane representation is a common practice for OFDM systems, which makes it intuitive for radio resource allocation. Each column and each row of the resource grid correspond to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements and in the frequency domain; this represents the smallest quanta of resources that currently can be allocated. There are several different physical downlink channels that are conveyed using such resource blocks. Two of these physical downlink channels are the physical downlink shared channel and the physical down link control channel.

The physical downlink shared channel (PDSCH) carries user data and higher-layer signaling to a UE 102. The physical downlink control channel (PDCCH) carries information about the transport format and resource allocations related to the PDSCH channel, among other things. It also informs the UE about the transport format, resource allocation, and hybrid automatic repeat request (H-ARQ) information related to the uplink shared channel. Typically, downlink scheduling (assigning control and shared channel resource blocks to UEs within a cell) is performed at the eNB based on channel quality information fed back from the UEs to the eNB, and then the downlink resource assignment information is sent to a UE on the control channel (PDCCH) used for (assigned to) the UE.

The PDCCH uses CCEs (control channel elements) to convey the control information. Before being mapped to resource elements, the PDCCH complex-valued symbols are first organized into quadruplets, which are then permuted using a sub-block inter-leaver for rate matching. Each PDCCH is transmitted using one or more of these control channel elements (CCEs), where each CCE corresponds to nine sets of four physical resource elements known as resource element groups (REGs). Four QPSK symbols are mapped to each REG. The PDCCH can be transmitted using one or more CCEs, depending on the size of downlink control information (DCI) and the channel condition. There may be four or more different PDCCH formats defined in LTE with different numbers of CCEs (e.g., aggregation level, L, =1, 2, 4, or 8). Enhanced PDCCH (EPDCCH) increases the control channel a capacity by using PDSCH resources to send additional control channel information.

A cell-specific reference signal (e.g., pilot symbols) can be inserted in communications in both time and frequency to facilitate the estimation of the channel characteristics of the RAN. The cell-specific reference signal (CRS) provides an estimate of the channel at given locations within a subframe. Through interpolation it is possible to estimate the channel across an arbitrary number of subframes. The reference signals in LTE are assigned positions within a subframe depending on the eNB cell identification number and which transmit antenna is being used. One CRS can be transmitted from each downlink antenna port (AP). Unique positioning of the reference signals reduces interference with one another and can be used to provide a reliable estimate of the complex gains imparted onto each resource element within the transmitted grid by the propagation channel. However, there can still be environments in which interference by reference signals from the cells neighboring to the serving cell can limit communication performance.

Additionally, multi-cast broadcast single frequency network (MBSFN) transmissions can cause interference. MBSFN is used for evolved multimedia broadcast multicasting service (eMBMS) such as broadcasting television programming. In eMBMS, multiple eNBs may transmit identical data (e.g., video data) simultaneously so that UE can receive the same data from multiple eNBs. An MBSFN subframe has a different structure than non-MBSFN subframes (e.g., some symbols may be different for an MBSFN subframe). The MBSFN subframes may not include cell-specific reference signals or may include cell-specific reference signals in a smaller number of OFDM symbols than regular downlink subframes. The number and location of MBSFN subframes and which subframes include a CRS may be determined by the RAN, and the MBSFN subframe pattern can be sent to the UE from eNBs of the RAN. However, the RAN may configure the MBSFN subframe pattern differently for different cells.

As explained previously herein, the interference from cell-specific reference signals may be a limiting factor for the down link performance. For example, the interference may negatively impact the performance of one or more of the downlink physical channels including a physical downlink shared channel (PDSCH), a physical downlink control channel (PDCCH), an enhanced PDCCH (EPDCCH), a physical control format indicator channel (PCFICH), and a physical hybrid ARQ indicator channel (PHICH). In order to improve the demodulation performance, the UE can include an inter-cell CRS interference mitigation (CRS-IM) receiver that can mitigate the dominant CRS interference from the neighboring cells.

An eNB may provide information to UE regarding the set of neighboring cells, and the set of different carriers where the UE may operate (e.g., primary cell (Pcell) information and information of a secondary cell (Scell) or cells). The UE can use this information in order to enable CRS-IM processing. In particular, UE may perform measurements of neighboring cells receive power (e.g., reference signal received power (RSRP)) to generate a list of CRS signal parameters of the neighboring cells. Interfering cells can be selected from the signaled list for CRS-IM processing. The selection may be done based on maximum power criteria (e.g., apply the CRS-IM to the one or two dominant interference cells) and other criteria (e.g., apply the CRS-IM for the interfering cells that have non-colliding CRS patterns).

CRS Assistance information sent from the eNB can assist UE in applying the correct CRS-IM processing to incoming signals. The CRS Assistance information can include the physical cell identifiers (Cell IDs), the number of CRS APs, and an MBSFN subframe configuration. The Cell IDs can be used to derive the CRS symbol sequence and derive a CRS resource element (RE) mapping. The information on the number of CRS APs may be used in order to apply CRS-IM processing for the correct number of CRS APs (e.g. 1, 2 or 4 APs), and can be used with the Cell-ID information to determine CRS RE mapping. The MBSFN subframe pattern information may be used to apply CRS-IM processing to MBSFN subframes that may include CRS (e.g., subframes of the control region) and to avoid applying CRS-IM processing to the MBSFN subframes that may not include CRS.

Advanced UE implementations may be capable of autonomous detection (or blind detection) of CRS Assistance information of neighboring cells, including physical cell identifier (Physical Cell ID), the number of CRS APs, and MBSFN subframe pattern information. The list of Physical cell IDs of the neighboring cells can be obtained autonomously by the UE during the regular Cell search and intra- and inter-frequency measurements procedures. Typically, UE maintains a list of characteristics including Cell ID, RSRP, and other parameters for multiple detected neighboring cells on different carriers. The number of CRS APs for the neighboring cells can be detected via direct CRS presence detection or via physical broadcast channel (PBCH) decoding. The MBSFN subframe pattern can be detected using CRS presence detection methods for neighboring cell, or using neighboring cell system information block (SIB) message decoding (e.g., SIB1 and SIB2 decoding).

The autonomous detection of the Physical Cell ID and the number of CRS APs can be relatively straightforward, and autonomous detection of this information does not impose substantial complexity in the implementation. However, the detection of the MBSFN subframe patterns may generally be relatively complex and unreliable because it requires acquisition of the neighboring cell system information (e.g., SIBs). Hence, some CRS Assistance signaling from the eNB may not be completely avoided.

A framework to minimize CRS Assistance signaling overhead, and overcome practical limitations of the autonomous or blind detection of CRS Assistance parameters involves a compromise between complete autonomous detection by the UE and complete CRS Assistance signaling from the eNB. The approach uses UE autonomous detection of the neighbouring cell parameters required for the CRS-IM operation including Physical Cell ID and number of CRS APs. Additionally, eNBs will provide CRS Assistance signalling to inform UEs of the MBSFN pattern parameters which are not expected to be blindly detected by the UEs. The corresponding CRS Assistance information is provided only in the case where one or both of the serving cell and the neighbouring cells use MBSFN subframe patterns. In the case where MBSFN patterns are not used in the network, or the same MBSFN subframe pattern configuration is used across the network, the eNBs do not provide CRS Assistance information. The UEs assume that the other cells have same MBSFN subframe configuration as the serving cell, or that cells are not configured for MBSFN transmitting.

According to existing LTE designs, eNBs are expected to provide CRS Assistance information parameters of the neighbouring cells to UEs in order to facilitate use of CRS-IM receivers at the UE side. The CRS Assistance information is provided to each UE independently and includes information on all or a subset of the neighbouring cells of the serving cell. Additionally, CRS Assistance information is provided for all or a subset of different component carriers. For areas of dense cell deployments and for multi-carrier operations, CRS Assistance signalling may impose substantial RRC signalling overhead.

The improved framework can substantially reduce the amount of corresponding RRC signalling needed to enable CRS-IM operation on the UE side, and can be beneficial for the overall network efficiency. The benefits may be especially realized for those networks that do not employ MBSFN subframes or have network-common MBSFN subframe configurations. Moreover, no impact on UE performance is foreseen due to the reliability of detection of the neighbouring cell Physical Cell IDs and the number of CRS APs.

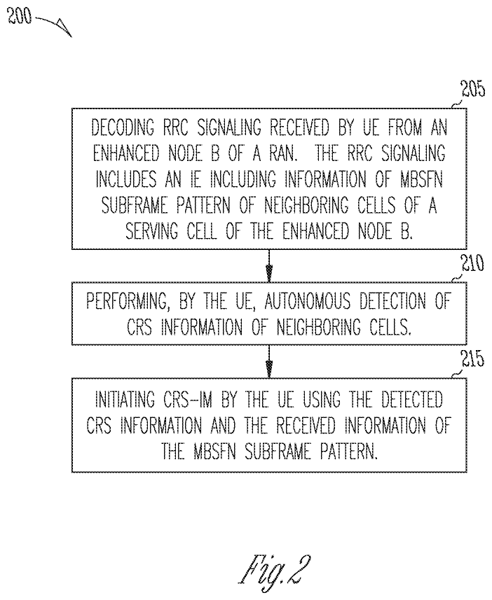

FIG. 2 is a flow diagram of a method 200 of implementing CRS-IM for UE of a RAN in an aspect. The method exploits two key characteristics of CRS Assistance information. The first characteristic is that detection of Physical Cell IDs of the neighboring cells and the number of CRS APs is feasible (in terms of UE complexity and reliability). The second is that the majority of the existing LTE networks do not use MBSFN, and the networks do not configure any MBSFN subframe patterns. Hence, the signaling or detection of this parameter is not required for the majority of conditions.

At 205, RRC signaling is received from an eNB of a RAN by UE and decoded by the UE. The RRC signaling includes an information element (IE). The IE includes information of the MBSFN subframe patterns of neighboring cells of the serving cell of the eNB. The RRC signaling does not include one or both of the Physical Cell IDs and the number of CRS APs of the neighboring cells. Instead, autonomous or blind detection of CRS information of neighboring cells is initiated by the UE at 210. The detected CRS information includes one or both of the Cell IDs and the number of CRS APs. At 215, the UE initiates CRS-IM using the detected CRS information and the received information of the MBSFN subframe patterns.

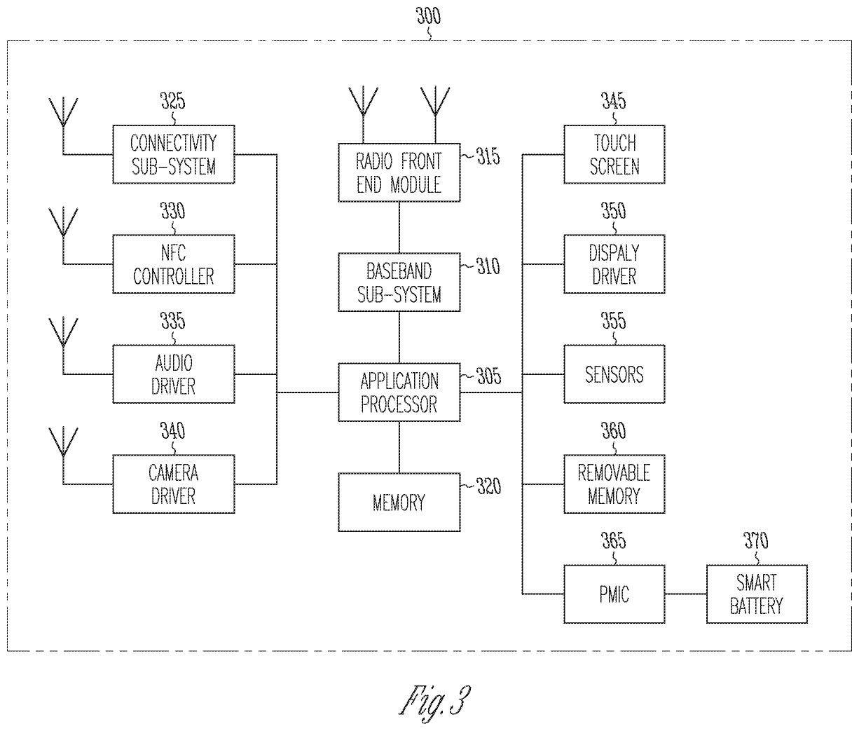

FIG. 3 illustrates user equipment (UE) in an aspect. The UE 300 may be a mobile device in some aspects and includes processing circuitry, such as an application processor 305 and a baseband processor 310 (also referred to as a baseband sub-system). The UE 300 also includes a radio front end module (RFEM) 315, memory 320, connectivity sub-system 325, near field communication (NFC) controller 330, audio driver 335, camera driver 340, touch screen 345, display driver 350, sensors 355, removable memory 360, power management integrated circuit (PMIC) 365 and smart battery 370. The RFEM 315 can include radio frequency transceiver circuitry connected to multiple antennas. In some aspects, the transceiver circuitry can include one or more radio frequency integrated circuits.

In some aspects, application processor 305 may include, for example, one or more CPU cores and one or more of cache memory, low drop-out voltage regulators (LDOs), interrupt controllers, serial interfaces such as serial peripheral interface (SPI), inter-integrated circuit (I²C) or universal programmable serial interface circuit, real time clock (RTC), timer-counters including interval and watchdog timers, general purpose input-output (10), memory card controllers such as secure digital/multi-media card (SD/MMC) or similar, universal serial bus (USB) interfaces, mobile industry processor interface (MIPI) interfaces and Joint Test Access Group (JTAG) test access ports.

In some aspects, baseband processor 310 may be implemented, for example, as a solder-down substrate including one or more integrated circuits, a single packaged integrated circuit soldered to a main circuit board, and/or a multi-chip module containing two or more integrated circuits.

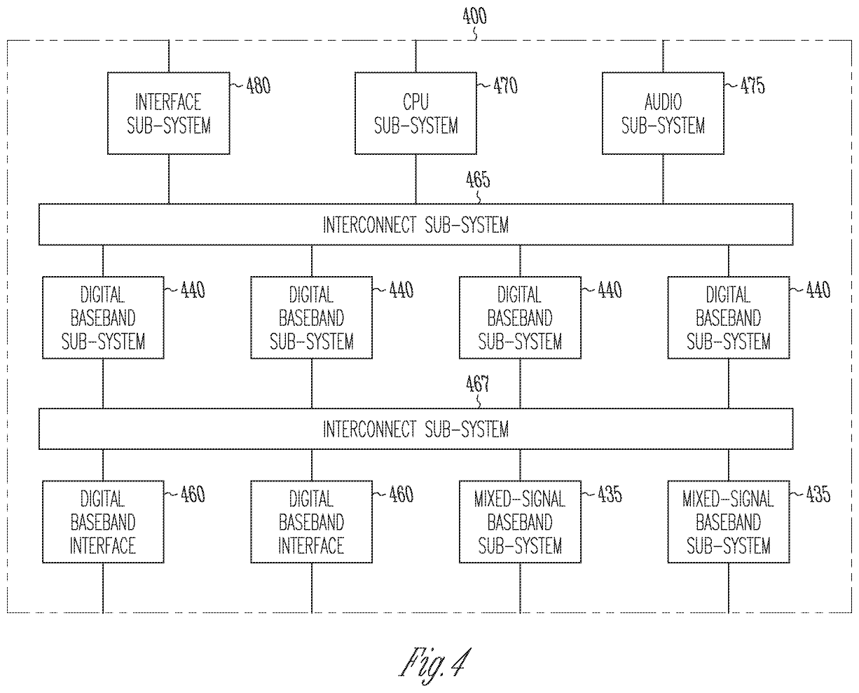

FIG. 4 illustrates a multi-protocol baseband processor 400 in an aspect, such as the baseband processor 310 of the UE in the example of FIG. 3. In an aspect, baseband processor may contain one or more digital baseband subsystems 440. In an aspect, the one or more digital baseband subsystems 440 may be coupled via interconnect subsystem 465 to one or more of CPU subsystem 470, audio subsystem 475 and interface subsystem 480.

In an aspect, the one or more digital baseband subsystems 440 may be coupled via interconnect subsystem 467 to one or more of each of digital baseband interface 460 and mixed-signal baseband sub-system 435. In an aspect, interconnect subsystem 465 and 467 may each include one or more each of buses point-to-point connections and network-on-chip (NOC) structures. In an aspect, audio sub-system 475 may include one or more of digital signal processing circuitry, buffer memory, program memory, speech processing accelerator circuitry, data converter circuitry such as analog-to-digital and digital-to-analog converter circuitry, and analog circuitry including one or more of amplifiers and filters.

Returning to FIG. 3, the processing circuitry of the UE 300 can perform the method example of FIG. 2. The processing circuitry decodes RRC signaling received from eNB of the RAN. The RRC signaling includes CRS Assistance signaling, and an IE with information of the MBSFN subframe pattern of one or more neighboring cells is included in the CRS Assistance signaling. As part of the CRS-IM, the processing circuitry of the UE (e.g., the baseband processor 310) initiates autonomous detection of CRS information of neighboring cells. The CRS information may include one or both of physical Cell IDs and a number of CRS APs of the one or more neighboring cells. The processing circuitry initiates CRS-IM using the detected CRS information and the received information of the MBSFN subframe patterns.

As explained previously herein, the Cell-ID, CRS AP information, and the information of the MBSFN subframe patterns assists the CRS-IM processing to be performed. In an aspect, the processing circuitry may mitigate the interference by the respective interference signal cancellation from the received signal. Blind detection of the Cell-ID allows the CRS-IM processing to derive the CRS sequence and subtract a reconstructed interfering CRS from the received signal. Blind detection of the Cell-ID and CRS AP information allows the CRS-IM processing to derive CRS RE mapping of the CRS APs to their respective channels or carriers and subtract an interfering CRS sequence from signal received on the carriers. In some aspects, the processing circuitry initiates measurements of receive power of cell reference signals received from the neighboring cells, selects cells to apply the CRS-IM according to the measurements of receive power, and initiates interference mitigation of signals from the selected cells.

The MBSFN subframe pattern information allows the UE to apply the CRM-IM processing to the correct subframes. In an aspect, the processing circuitry receives the information of MBSFN subframe patterns for each component carrier of the neighboring cells, and initiates measurements of receive power of signals received from the neighboring cells. The component carriers for the CRS-IM processing are selected according to the measurements of receive power. The processing circuitry initiates interference mitigation of signals from the selected component carriers using the received information of the MBSFN subframe patterns.

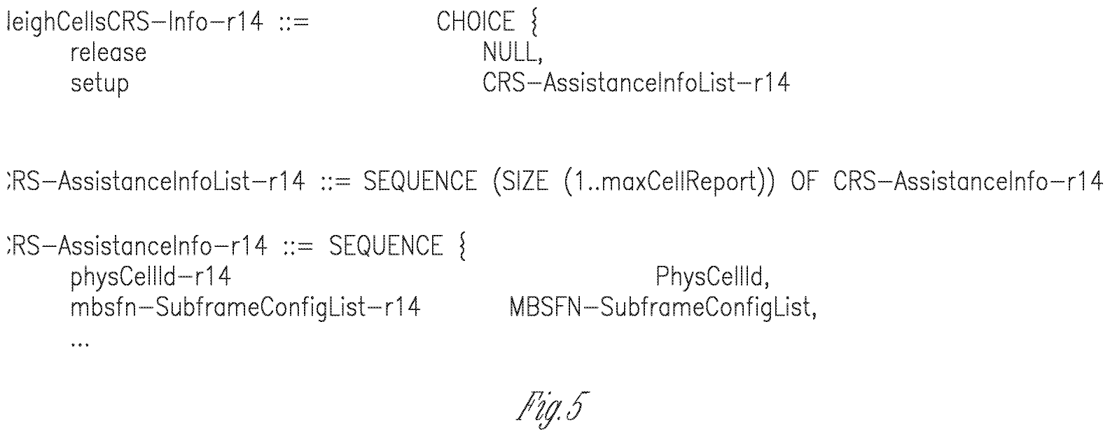

The UE does not perform blind detection of the MBSFN subframe patterns. Instead, information on the MBSFN subframe pattern of the neighboring cells is provided as CRS Assistance information from an eNB using a new type of RRC signaling that does not include information on the number of CRS APs. FIG. 5 shows an example of IEs received by the UE for new CRS Assistance in an aspect. In the example shown, the IEs include a Physical Cell-ID IE (physCellID) and an MBSFN IE (MBSFN-SubframeConfiglist), but do not include an IE for CRS APs. The processing circuitry of the UE 300 may store CRS Assistance IEs received from the eNB in the memory 320.

The new CRS Assistance signaling can be avoided in some circumstances. In some aspects, the eNB may not send information of MBSFN subframe patterns because the neighboring cells may not be configured for MBSFN operation. In some aspects, the processing circuitry of the UE may assume there are no MBSFN subframes when information of the MBSFN subframe patterns of the neighboring cells is not provided by the eNB. In some aspects, the eNB may not send MBSFN subframe pattern information when the neighboring cells use the same MBSFN subframe pattern as the serving cell. In this case, it is assumed that the neighboring cells uses the same MBSFN patterns as the serving cell, and the processing circuitry of the UE uses the MBSFN subframe pattern of the serving cell for the CRS-IM when the MBSFN subframe pattern information of the neighboring cells is not provided by the eNB. In some aspects, the eNB may indicate to the UE that the neighboring cell uses same MBSFN subframe pattern information as the serving cell.

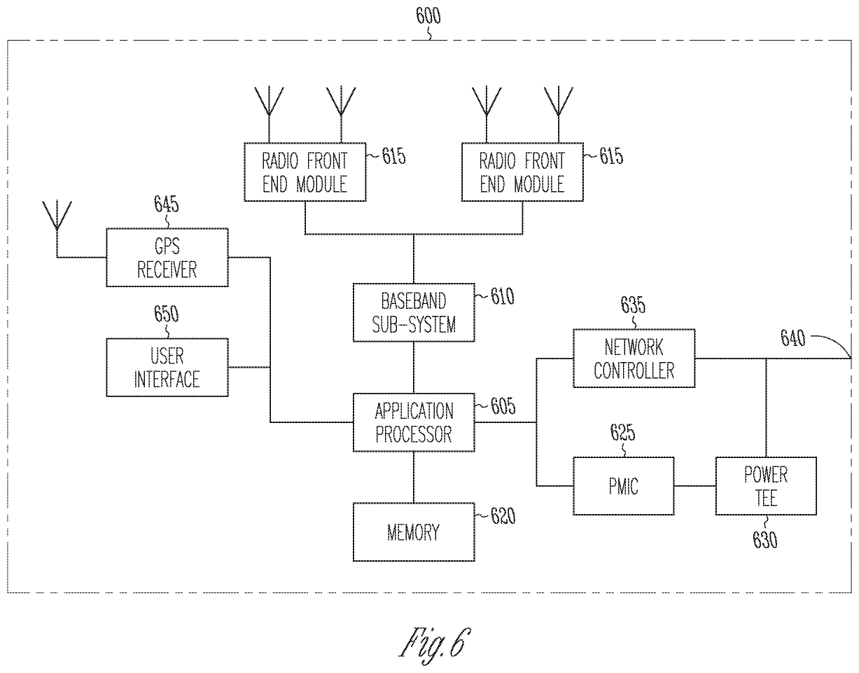

FIG. 6 illustrates an eNB 600 in an aspect. The eNB 600 may include processing circuitry that includes one or more of application processor 605 and baseband processor 610. The eNB can also include one or more radio front end modules 615, memory 620, power management integrated circuitry 625, power tee circuitry 630, network controller 635, network interface connector 640, satellite navigation receiver 645, and user interface 650.

In some aspects, application processor 605 may include one or more CPU cores and one or more of cache memory, low drop-out voltage regulators (LDOs), interrupt controllers, serial interfaces such as SPI, I2C or universal programmable serial interface, real time clock (RTC), timer-counters including interval and watchdog timers, general purpose 10, memory card controllers such as SD/MMC or similar, USB interfaces, MIPI interfaces and Joint Test Access Group (JTAG) test access ports.

In some aspects, baseband processor 610 may be implemented, for example, as a solder-down substrate including one or more integrated circuits, a single packaged integrated circuit soldered to a main circuit board or a multi-chip module containing two or more integrated circuits.

In some aspects, memory 620 may include one or more of volatile memory including dynamic random access memory (DRAM) and/or synchronous dynamic random access memory (SDRAM), and nonvolatile memory (NVM) including high-speed electrically erasable memory (commonly referred to as Flash memory), phase change random access memory (PRAM), magnetoresistive random access memory (MRAM) and/or a three-dimensional crosspoint memory. Memory 620 may be implemented as one or more of solder down packaged integrated circuits, socketed memory modules and plug-in memory cards.

In some aspects, power management integrated circuitry 625 may include one or more of voltage regulators, surge protectors, power alarm detection circuitry and one or more backup power sources such as a battery or capacitor. Power alarm detection circuitry may detect one or more of brown out (under-voltage) and surge (over-voltage) conditions. In some aspects, power tee circuitry 630 may provide for electrical power drawn from a network cable to provide both power supply and data connectivity to eNB 400 using a single cable.

In some aspects, network controller 635 may provide connectivity to a Third Generation Partnership Project Long Term Evolution (3GPP LTE) RAN, or a fourth generation (4G) network. The connectivity may be provided using a physical connection which is one of electrical (commonly referred to as copper interconnect), optical, or wireless.

In some aspects, satellite navigation receiver 645 may include circuitry to receive and decode signals transmitted by one or more navigation satellite constellations such as one or more of the global positioning system (GPS), Globalnaya Navigatsionnaya Sputnikovaya Sistema (GLONASS), Galileo and BeiDou. The satellite navigation receiver 645 may provide data to application processor 605 which may include one or more of position data or time data. Application processor 605 may use time data to synchronize operations with other radio base stations. In some aspects, user interface 650 may include one or more of physical or virtual buttons, such as a reset button, one or more indicators such as light emitting diodes (LEDs) and a display screen.

The memory 620 can be used to store the MBSFN subframe pattern information of the neighboring cells. The processing circuitry of the eNB determines information related to the MBSFN subframe patterns of the neighboring cells. The information may be received by the eNB from the backhaul of the network, or the information may be previously stored in the memory of the eNB. The processing circuitry of the eNB encodes an IE of CRS Assistance for transmission to the UE using RRC signaling. The IE includes information of the MBSFN subframe pattern or patterns of neighboring cells of the eNB. FIG. 5 shows an example of CRS Assistance IEs transmitted to the UE by the eNB. The example includes an IE for a physical Cell-ID and an IE for the MBSFN subframe pattern information, and excludes an IE for CRS APs. In some aspects, the processing circuitry only encodes an IE for the MBSFN subframe pattern information, and the Cell ID information is determined autonomously by the UE.

In some aspects, processing circuitry (e.g., baseband processor 610 of FIG. 6) encodes IEs of the MBSFN subframe pattern information for each component carrier of the neighboring cells for transmission to the UE. The UE may perform autonomous detection of cell-IDs and CRS-APs of the neighboring cells, and perform CRS-IM using the detected cell-ID and CRS-AP information and the transmitted information of MBSFN subframe patterns.

In some aspects, the processing circuitry only sends the MBSFN subframe pattern information of neighboring cells when the neighboring cells have configured MBSFN subframe patterns, and does not send the MBSFN subframe pattern information when neighboring cells do not have configured MBSFN subframe patterns.

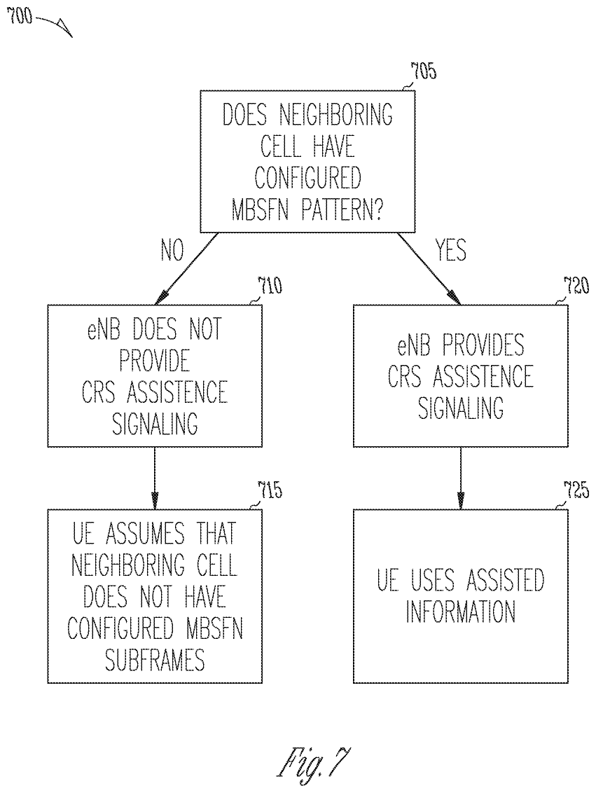

FIG. 7 is a flow diagram of a method 700 of sending CRS Assistance signaling in an aspect. At 705, it is determined whether the neighboring cells of the serving cell are configured to send MBSFN subframes. If they are not configured to send MBSFN subframes, at 710 the eNB does not provide CRS Assistance signaling, and the information of MBSFN subframe patterns is not sent by the eNB. At 715, the UE assumes that the neighboring cells are not configured to send MBSFN subframes and the UE performs CRS-IM using the detected cell-ID and CRS-AP information, and not using information related to MBSFN subframe patterns. If the neighboring cells are configured to transmit MBSFN patterns, at 720 the eNB sends CRS Assistance signaling, and the UE performs CRS-IM using the detected cell-ID and CRS-AP information, and the information related to MBSFN subframe patterns provided in the CRS Assistance signaling.

In some aspects, the processing circuitry only sends the information of MBSFN subframe patterns of the neighboring cells when the MBSFN subframe pattern information is different from MBSFN subframe pattern information for the serving cell of the eNB. The processing circuitry does not send the information of MBSFN subframe patterns of the neighboring cells when the MBSFN subframe pattern of the neighboring cells is the same as the MBSFN subframe pattern of the serving cell of the eNB.

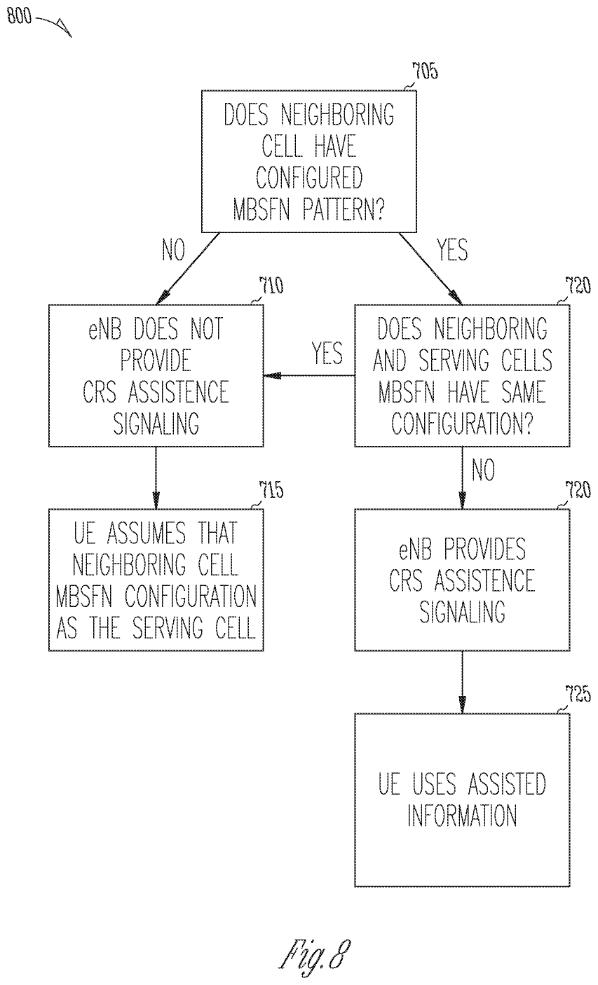

FIG. 8 is a flow diagram of a method 800 of sending CRS Assistance signaling. At 805, it is determined whether the neighboring cells of the serving cell are configured to send MBSFN subframes. If the cells are not configured to send MBSFN subframes, at 810 the eNB does not provide CRS Assistance signaling to UE, and the UE performs CRS-IM using the blindly detected cell-ID information and the detected CRS-AP information.

If the neighboring cells are configured to transmit MBSFN subframe patterns it is determined at 820 whether the neighboring cells are configured with the same MBSFN subframe pattern as the serving cell. If the cells are configured the same as the serving cell, the eNB again does not provide CRS Assistance signaling at 810. At 815 however, the UE still uses the information of MBSFN subframe patterns when performing CRS-IM, but the UE uses the same MBSFN subframe pattern as the serving cell for the CRS-IM under the assumption that all the cells are configured the same.

At 825, if the neighboring cells are not configured with the same MBSFN subframe pattern as the serving cell, the eNB sends CRS Assistance signaling. At 830, the UE performs CRS-IM using the detected cell-ID and CRS-AP information and the MBSFN subframe pattern information provided in the CRS Assistance signaling.

The several aspects described herein minimize CRS Assistance signaling to reduce RRC signaling overhead. The CRS Assistance signaling is minimized using a combination of autonomous detection by UE of parameters used for CRS-IM, and overcoming practical limitations of autonomous detection by sending a reduced number of CRS Assistance parameters only when the parameters will be used in the CRS-IM by the UE.

### Additional Description and Examples

Example 1 includes subject matter (such as an apparatus of UE) comprising processing circuitry and memory. The processing circuitry is configured to decode radio resource control (RRC) signaling received from an enhanced node B (eNB), wherein the RRC signaling includes an information element (IE) including information of a multi-cast broadcast single frequency network (MBSFN) subframe pattern of neighboring cells of a serving cell of the eNB; initiate detection of cell specific reference signal (CRS) information of the neighboring cells by the UE, the CRS information including one or both of physical cell identifiers (Cell IDs) and a number of CRS antenna ports (APs) of the neighboring cells; and initiate neighboring cell CRS interference mitigation (CRS-IM) using the detected CRS information and the received information of the MBSFN subframe pattern. The memory is configured to store the information of the MBSFN subframe pattern.

In Example 2, the subject matter of Example 1 optionally includes processing circuitry configured to use information of a MBSFN subframe pattern of the serving cell for the CRS-IM when the IE including the information of the MBSFN subframe pattern of the neighboring cells is not provided by the eNB.

In Example 3, the subject matter of one or both of Examples 1 and 2 optionally include RRC signaling that includes an IE including a Cell ID of a neighboring cell and the IE including the information of the MBSFN subframe pattern, and the RRC signaling does not include information on the number of CRS APs.

In Example 4, the subject matter of one or any combination of Examples 1-3 optionally includes processing circuitry configured to: initiate measurements of receive power of CRSs received from the neighboring cells; select cells to apply the CRS-IM according to the measurements of receive power; and initiate interference mitigation of signals from the selected cells.

In Example 5, the subject matter of one or any combination of Examples 1-4 optionally include processing circuitry configured to detect a number of CRS APs of the neighboring cells; and map CRS resource elements (REs) for the CRS-IM using the detected CRS APs.

In Example 6, the subject matter of one or any combination of Examples 1-5 optionally includes processing circuitry configured to exclude the information of the MBSFN subframe pattern from the CRS-IM when the IE including the information of the MBSFN subframe pattern of the neighboring cells is not provided by the eNB.

In Example 7, the subject matter of one or any combination of Examples 1-6 optionally includes processing circuitry configured to: receive information of a MBSFN subframe pattern for each component carrier of the neighboring cells; initiate measurements of receive power of CRSs received from the neighboring cells and select component carriers for the CRS-IM according to the measurements of receive power, and initiate interference mitigation of signals from the selected component carriers using the received information of the MBSFN subframe pattern and the detected CRS information.

In Example 8, the subject matter of one or any combination of Examples 1-7 optionally includes UE configured to detect both of a Cell ID and a number of CRS APs of a neighboring cell of the serving cell of the eNB, and processing circuitry configured to derive a CRS sequence and a CRS resource element (RE) mapping of the neighboring cell using the Cell ID and a number of CRS APs, and perform the CRS-IM of the neighboring cell using the derived CRS sequence and CRS RE mapping.

In Example 9, the subject matter of one or any combination of Examples 1-8 optionally includes processing circuitry comprising a baseband processor.

In Example 10, the subject matter of one or any combination of Examples 1-9 optionally includes transceiver circuitry operatively coupled to the processing circuitry and two or more antennas.

Example 11 includes subject matter (such as an enhanced node B (eNB) configured for operation in a radio access network (RAN)), or can optionally be combined with one or more of Examples 1-10 to include such subject matter, comprising processing circuitry and memory. The processing circuitry is configured to: determine information of a multi-cast broadcast single frequency network (MBSFN) subframe pattern of neighboring cells of a serving cell of the eNB; and encode an information element (IE) of cell reference signal (CRS) assistance for transmission to user equipment (UE) using radio resource control (RRC) signaling, the IE including the information of the MBSFN subframe pattern of the neighboring cells. The memory is configured to store the information of the MBSFN subframe pattern of the neighboring cells.

In Example 12, the subject matter of Example 11 optionally includes processing circuitry configured to send the IE including the information of the MBSFN subframe pattern of the neighboring cells to the UE when the MBSFN subframe pattern of the neighboring cells is different from an MBSFN subframe pattern of the serving cell of the eNB, and to not send the IE including the information of the MBSFN subframe pattern of the neighboring cells when the MBSFN subframe pattern of the neighboring cells is the same as the MBSFN subframe pattern of the serving cell of the eNB.

In Example 13, the subject matter of one or both of Examples 11 and 12 optionally includes processing circuitry configured to send the IE including the information of the MBSFN subframe pattern of neighboring cells when the neighboring cells have configured MBSFN subframe patterns, and to not send the IE including the information of the MBSFN subframe pattern when neighboring cells do not have configured MBSFN subframe patterns.

In Example 14, the subject matter of one or any combination of Examples 11-13 optionally includes processing circuitry is configured to encode an IE including information of a physical cell identifier (Cell ID) of a neighboring cell: send the IE including information of the Cell ID and the IE including the information of the MBSFN subframe pattern to the UE: and not send information of the number CRS APs to the UE.

In Example 15, the subject matter of one or any combination of Examples 11-14 optionally includes processing circuitry configured to encode information of a MBSFN subframe pattern for each component carrier of the neighboring cells for transmission to the UE.

In Example 16, the subject matter of one or any combination of Examples 11-15 optionally includes the RAN being a Third Generation Partnership Project Long Term Evolution (3GPP LTE) RAN.

Example 17 includes subject matter (such as a computer-readable storage medium that stores instructions for execution by one or more processors of user equipment (UE) to perform operations to configure the UE), or can optionally be combined with one or more of Examples 1-16 to include such subject matter, comprising: decoding radio resource control (RRC) signaling received from an enhanced node B (eNB) of a radio access network (RAN), the RRC signaling to include an information element (IE) including information of a multi-cast broadcast single frequency network (MBSFN) subframe pattern of neighboring cells of a serving cell of the eNB: initiating detection of CRS information of neighboring cells by the UE, the CRS information including one or both of physical cell identifiers (Cell IDs) and a number of CRS antenna ports (APs) of the neighboring cells; and initiating CRS interference mitigation (CRS-IM) using the detected CRS information and the received IE including the information of the MBSFN subframe pattern.

In Example 18, the subject matter of Example 17 optionally includes instructions that cause the one or more processors of the UE to perform operations to configure the UE to use information of a MBSFN subframe pattern information of the serving cell of the eNB for the CRS-IM when the IE including the information of the MBSFN subframe pattern of neighboring cells is not provided by the eNB.

In Example 19, the subject matter of one or both of Examples 17 and 18 optionally include instructions that cause the one or more processors of the UE to perform operations to configure the UE to perform the CRS-IM to exclude mitigating MBSFN subframe patterns of the neighboring cells when the MBSFN subframe pattern information of the neighboring cells is not provided by the eNB.

In Example 20, the subject matter of one or any combination of Examples 17-19 optionally includes instructions that cause the one or more processors of the UE to perform operations to: initiate measurements of receive power of CRSs received from the neighboring cells, select cells to apply the CRS-IM according to the measurements of receive power, and initiate interference mitigation of signals from the selected cells.

These non-limiting examples can be combined in any permutation or combination. The above detailed description includes references to the accompanying drawings, which form a part of the detailed description. The drawings show, by way of illustration, specific embodiments that can be practiced. These embodiments are also referred to herein as “examples.” All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Method examples described herein can be machine or computer-implemented at least in part. Some examples can include a computer-readable storage medium or machine-readable storage medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. The code can be tangibly stored on one or more volatile, non-transitory, or non-volatile tangible computer-readable media, such as during execution or at other times. Examples of these tangible computer-readable storage media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment. Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

1.-16. (canceled)

17. An apparatus of user equipment (UE), the apparatus comprising:
processing circuitry configured to:
decode radio resource control (RRC) signaling received from an enhanced node B (eNB), wherein the RRC signaling includes an information element (IE) including information of a multi-cast broadcast single frequency network (MBSFN) subframe pattern of neighboring cells of a serving cell of the eNB;
initiate detection of cell specific reference signal (CRS) information of the neighboring cells by the UE, the CRS information including one or both of physical cell identifiers (Cell IDs) and a number of CRS antenna ports (APs) of the neighboring cells; and
initiate neighboring cell CRS interference mitigation (CRS-IM) using the detected CRS information and the received information of the MBSFN subframe pattern; and
memory configured to store the information of the MBSFN subframe pattern.

18. The apparatus of claim 17, wherein the processing circuitry is configured to use information of a MBSFN subframe pattern of the serving cell for the CRS-IM when the IE including the information of the MBSFN subframe pattern of the neighboring cells is not provided by the eNB.

19. The apparatus of claim 17, wherein the RRC signaling includes an IE including a Cell ID of a neighboring cell and the IE including the information of the MBSFN subframe pattern, and the RRC signaling does not include information on the number of CRS APs.

20. The apparatus of claim 17, wherein the processing circuitry is configured to:
initiate measurements of receive power of CRSs received from the neighboring cells;
select cells to apply the CRS-IM according to the measurements of receive power; and
initiate interference mitigation of signals from the selected cells.

21. The apparatus of claim 17, wherein the processing circuitry is configured to:
detect a number of CRS APs of the neighboring cells; and
map CRS resource elements (REs) for the CRS-IM using the detected CRS APs.

22. The apparatus of claim 17, wherein the processing circuitry is configured to exclude the information of the MBSFN subframe pattern from the CRS-IM when the IE including the information of the MBSFN subframe pattern of the neighboring cells is not provided by the eNB.

23. The apparatus of any one of claim 17, wherein the processing circuitry is configured to:
receive information of a MBSFN subframe pattern for each component carrier of the neighboring cells;
initiate measurements of receive power of CRSs received from the neighboring cells and select component carriers for the CRS-IM according to the measurements of receive power; and
initiate interference mitigation of signals from the selected component carriers using the received information of the MBSFN subframe pattern and the detected CRS information.

24. The apparatus of claim 17, wherein the UE is configured to detect both of a Cell ID and a number of CRS APs of a neighboring cell of the serving cell of the eNB, and the processing circuitry is configured to derive a CRS sequence and a CRS resource element (RE) mapping of the neighboring cell using the Cell ID and a number of CRS APs, and perform the CRS-IM of the neighboring cell using the derived CRS sequence and CRS RE mapping.

25. The apparatus of claim 17, wherein the processing circuitry comprises a baseband processor.

26. The apparatus of claim 17, further comprising transceiver circuitry operatively coupled to the processing circuitry and two or more antennas.

27. An apparatus of an enhanced node B (eNB) configured for operation in a radio access network (RAN), the apparatus comprising:
processing circuitry configured to:
determine information of a multi-cast broadcast single frequency network (MBSFN) subframe pattern of neighboring cells of a serving cell of the eNB; and
encode an information element (IE) of cell reference signal (CRS) assistance for transmission to user equipment (UE) using radio resource control (RRC) signaling, the IE including the information of the MBSFN subframe pattern of the neighboring cells; and
memory configured to store the information of the MBSFN subframe pattern of the neighboring cells.

28. The apparatus of claim 27, wherein the processing circuitry is configured to send the IE including the information of the MBSFN subframe pattern of the neighboring cells to the UE when the MBSFN subframe pattern of the neighboring cells is different from an MBSFN subframe pattern of the serving cell of the eNB, and to not send the IE including the information of the MBSFN subframe pattern of the neighboring cells when the MBSFN subframe pattern of the neighboring cells is the same as the MBSFN subframe pattern of the serving cell of the eNB.

29. The apparatus of claim 27, wherein the processing circuitry is configured to send the IE including the information of the MBSFN subframe pattern of neighboring cells when the neighboring cells have configured MBSFN subframe patterns, and to not send the IE including the information of the MBSFN subframe pattern when neighboring cells do not have configured MBSFN subframe patterns.

30. The apparatus of claim 27, wherein the processing circuitry is configured to encode an IE including information of a physical cell identifier (Cell ID) of a neighboring cell; send the IE including information of the Cell ID and the IE including the information of the MBSFN subframe pattern to the UE; and not send information of the number CRS APs to the UE.

31. The apparatus of claim 27, wherein the processing circuitry is configured to encode information of a MBSFN subframe pattern for each component carrier of the neighboring cells for transmission to the UE.

32. The apparatus of any one of claim 27, wherein the RAN is a Third Generation Partnership Project Long Term Evolution (3GPP LTE) RAN.

33. A non-transitory computer-readable storage medium that stores instructions for execution by one or more processors of user equipment (UE) to perform operations to configure the UE to:
decode radio resource control (RRC) signaling received from an enhanced node B (eNB) of a radio access network (RAN), the RRC signaling to include an information element (IE) including information of a multi-cast broadcast single frequency network (MBSFN) subframe pattern of neighboring cells of a serving cell of the eNB;
initiate detection of CRS information of neighboring cells by the UE, the CRS information including one or both of physical cell identifiers (Cell IDs) and a number of CRS antenna ports (APs) of the neighboring cells; and
initiate CRS interference mitigation (CRS-IM) using the detected CRS information and the received IE including the information of the MBSFN subframe pattern.

34. The non-transitory computer-readable storage medium of claim 33, including instructions that cause the one or more processors of the UE to perform operations to configure the UE to use information of a MBSFN subframe pattern information of the serving cell of the eNB for the CRS-IM when the IE including the information of the MBSFN subframe pattern of neighboring cells is not provided by the eNB.

35. The non-transitory computer-readable storage medium of claim 33, including instructions that cause the one or more processors of the UE to perform operations to configure the UE to perform the CRS-IM to exclude mitigating MBSFN subframe patterns of the neighboring cells when the MBSFN subframe pattern information of the neighboring cells is not provided by the eNB.

36. The non-transitory computer-readable storage medium of any one of claim 33, including instructions that cause the one or more processors of the UE to perform operations to:
initiate measurements of receive power of CRSs received from the neighboring cells;
select cells to apply the CRS-IM according to the measurements of receive power; and
initiate interference mitigation of signals from the selected cells.
